(19) United States
(12) Patent Application Publication
(10) Pub. No.: US 2004/0032064 A1
(43) Pub. Date: Feb. 19, 2004

(54) Tunable pneumatic mount

(76) Inventor: James Joshua Jackson, Virginia Beach, VA (US)

Correspondence Address: HUNTON & WILLIAMS, Intellectual Property Department, 1900 K Street, N.W., Suite1200, Washington, DC, 20006-1109, US

(21) Appl. No.: 10/217,789

(22) Filed: Aug. 13, 2002

(51) Int. Cl. F16F 5/00

(52) U.S. Cl. 267/64.11

(57) ABSTRACT

A pneumatic equipment mount comprises a base plate and an annular outer case extending upwardly from the base plate. The annular outer case has opposing upper and lower case ends, the lower case end being closed by the base plate. The outer case comprises a case wall defining a cylindrical case inner surface. The pneumatic equipment mount also comprises a load platform comprising a substantially circular upper plate and a cylindrical mounting wall. The cylindrical mounting wall has a cylindrical mounting wall outer surface and is coaxially mounted to the upper plate. The cylindrical mounting wall is mounted adjacent the outer circumference of the upper plate so that the cylindrical mounting wall extends downwardly therefrom. The pneumatic equipment mount further comprises a toroidal shear element comprising a cylindrical outer toroid surface attached to a portion of the cylindrical case inner surface and having a cylindrical inner toroid surface attached to a portion of the cylindrical mounting wall outer surface. The inner and outer toroid surfaces are connected by upper and lower toroid surfaces. The toroidal shear element is formed from an elastomeric material. The base plate, the annular outer case, the load platform and the toroidal shear element combine to define a pressure chamber.

### FIELD OF THE INVENTION

The invention relates generally to isolation systems used to support and isolate structures and more particularly to a tunable, high load capacity equipment mount.

### BACKGROUND OF THE INVENTION

Large structures and heavy equipment are often mounted on pneumatic springs to provide low frequency (i.e., less than 5 Hz.) vibration isolation of the structure from the ground, other structures, or the deck or hull of a ship. Such springs are typically of the bellows or rolling lobe type, each of which make use of a flexible, annular member that may be pressurized and disposed between the isolated structure and a substrate. While such springs can provide adequate low frequency isolation, their performance is subject to degradation over time due to leakage associated with aging of the flexible annular member. Moreover, in order to maintain their low frequency capability, these springs are generally limited to loads up to about 50,000 lbs. Massive structures therefore require large numbers of such springs, which take up valuable space that could otherwise be used for structure and equipment.

Conventional pneumatic springs also have a significant disadvantage in that their response to low frequency vibration is essentially invariable once they are installed and loaded.

### SUMMARY OF THE INVENTION

The invention provides a simple, low cost, high capacity, low frequency equipment mount whose response may be tuned after installation and loading.

An embodiment of the invention provides a pneumatic equipment mount comprising a base plate and an annular outer case extending upwardly from the base plate. The annular outer case has opposing upper and lower case ends, the lower case end being closed by the base plate. The outer case comprises a case wall defining a cylindrical case inner surface. The pneumatic equipment mount also comprises a load platform comprising a substantially circular upper plate and a cylindrical mounting wall. The cylindrical mounting wall has a cylindrical mounting wall outer surface and is coaxially mounted to the upper plate. The cylindrical mounting wall is mounted adjacent the outer circumference of the upper plate so that the cylindrical mounting wall extends downwardly therefrom. The pneumatic equipment mount further comprises a toroidal shear element comprising a cylindrical outer toroid surface attached to a portion of the cylindrical case inner surface and having a cylindrical inner toroid surface attached to a portion of the cylindrical mounting wall outer surface. The inner and outer toroid surfaces are connected by upper and lower toroid surfaces. The toroidal shear element is formed from an elastomeric material. The base plate, the annular outer case, the load platform and the toroidal shear element combine to define a pressure chamber.

Other objects and advantages of the invention will be apparent to one of ordinary skill in the art upon reviewing the detailed description of the invention.

### BRIEF DESCRIPTION OF THE DRAWINGS

FIG. 1 is a perspective view of an equipment mount according to an embodiment of the invention;

FIG. 2 is a section view of an equipment mount according to an embodiment of the invention; and

FIG. 3 is a graphical representation of the transfer impedance performance of a modeled equipment mount according to an embodiment of the invention.

### DETAILED DESCRIPTION OF THE INVENTION

The invention provides a pneumatic equipment mount that is capable of maintaining vibration and shock isolation under a wide range of loads. The equipment mount is a pressure vessel comprising a cylindrical outer case mounted to a base plate and a coaxial circular load platform that fits within the open end of the outer case. A toroidal elastomeric shear element attached to the load platform and the outer case serves to attach the load platform to the outer case and to seal the pressure vessel. In use, the base plate is fixed to a substrate and a load attached to the load platform. The vessel is pressurized to a predetermined pressure commensurate with the mass of the load and the frequency range desired.

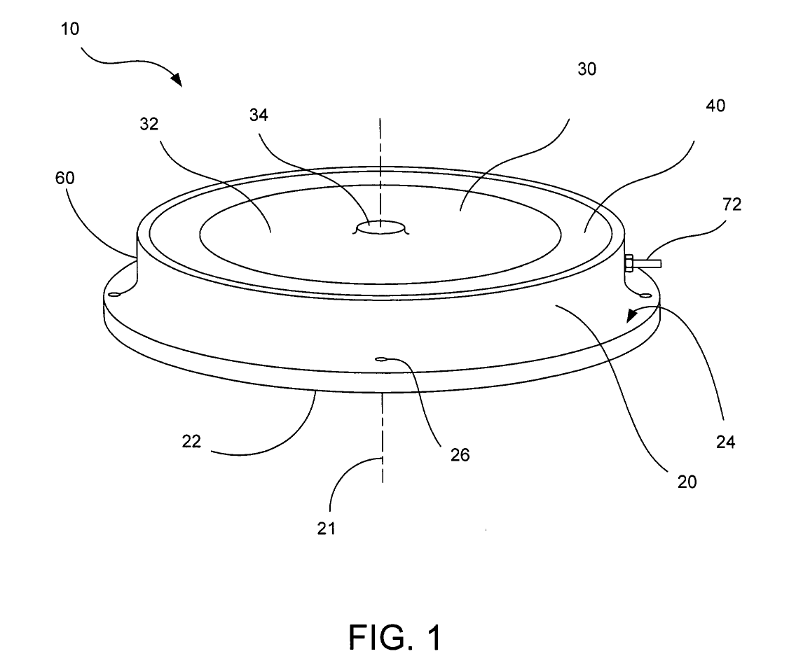

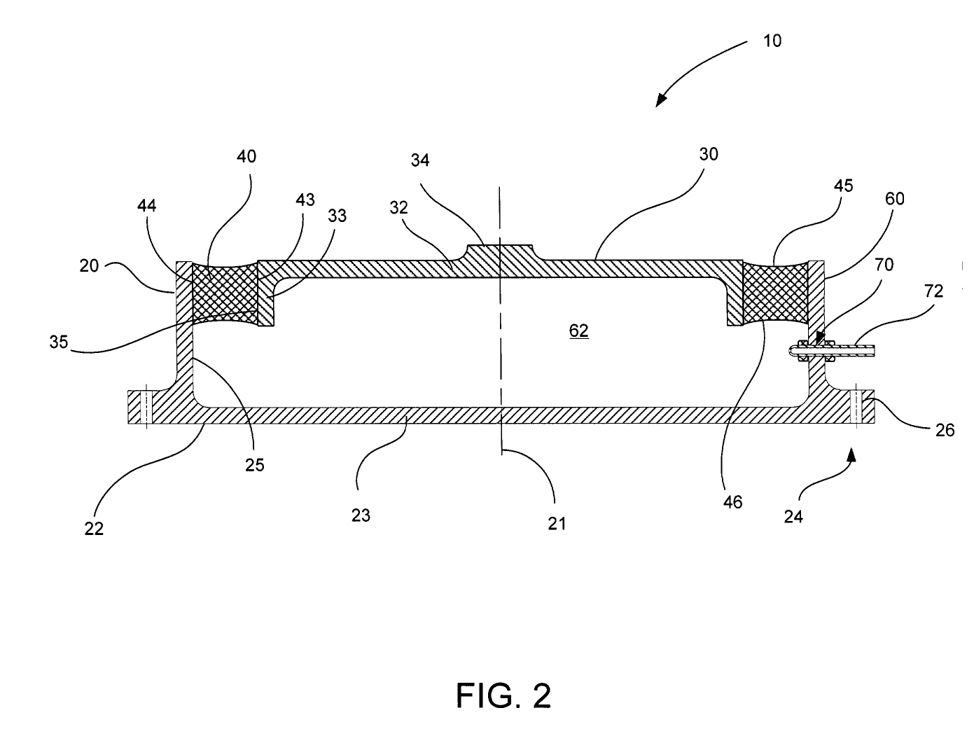

The invention will now be described in more detail. With reference to FIGS. 1 and 2, an equipment mount 10 comprises an annular cylindrical outer case 20, a base plate 22, a load platform 30 and a shear element 40 that combine to form a pressure vessel 60 defining a chamber 62. The base plate 22 is a substantially circular disk having a central portion that forms the bottom wall 23 of the pressure vessel 60 and an outer portion that serves as a mounting flange 24 for the equipment mount 10. Mounting holes 26 may be formed in the mounting flange 24 for use in conjunction with mounting bolts or other fasteners in fastening the equipment mount 10 to a substrate. The outer case 20 is mounted to the base plate 22 so that it extends upward therefrom and so that the cylindrical outer case 20 and the circular base plate 22 have a common central axis 21. The outer case 20 and the base plate 22 are preferably integrally formed from steel or other materials suitable for use in pressure vessels subjected to pressures up to 500 psi. The outer case 20 and base plate 22 may, for example, be formed from a single stainless steel forging machined to the desired dimensions. A stainless steel casting may also be used. Depending on the loading requirements, weight limitations, and operating environment, other materials may also be used including but not limited to high strength steel, carbon steel alloys, titanium alloys and composite materials. The outer case 20 and base plate 22 may also be formed separately and joined in any manner suitable for withstanding the operational environment and internal pressures.

The load platform 30 is formed from a substantially circular upper plate 32 and a cylindrical mounting wall 33. The cylindrical mounting wall 33 is coaxially mounted to the upper plate 32 adjacent the outer circumference of the upper plate 32 so that the cylindrical mounting wall 33 extends downwardly therefrom. The upper plate 32 and the mounting wall 33 are preferably integrally formed from stainless steel or other suitable materials including but not limited to high strength steel, carbon steel alloys, titanium alloys and composite materials.

The load platform 30 may have a raised central area 34 for engaging and supporting the load. The load platform 30 may also include an attaching arrangement (not shown) for attaching the load to the load platform 30. This may include, for example, one or more threaded rods attached to or threaded through holes in the upper plate 32. The attaching arrangement could also include clamps or latches configured to engage a particular load structure.

The shear element 40 is a toroidal structure formed from an elastomeric material that is preferably bondable to the outer case 20 and the mounting wall 33. The shear element has a cylindrical inner surface 43 that may be bonded to the outer surface 35 of the mounting wall 33 and a cylindrical outer surface 44 that may be bonded to the inner surface 25 of the outer case 20. The shear element 40 has a substantially rectangular cross section. The shear element upper surface 45 and lower surface 46 may, however, be slightly concave in order to reduce the potential for stress concentration near the inner and outer surfaces 43, 44 where the shear element 40 is bonded to the outer wall 20 and the mounting wall 33. The shear element 40 has a shear element thickness dimension that is defined as the average linear distance between the upper and lower surfaces 45, 46 measured parallel to the central axis of the toroidal structure.

The shear element 40 may be formed from any elastomeric material having sufficient strength to withstand the shear forces experienced by the shear element 40 when the pressure vessel 60 is pressurized and loaded. Suitable materials may include any natural or synthetic rubber with a hardness in a Shore A durometer range of about 30-70. In a preferred embodiment, the shear element 40 is formed from neoprene. The elastomeric material preferably has a hardness in a Shore A durometer range of 40-60 and the shear element 40 is preferably a single, integral structure formed by molding the elastomeric material. The shear element 40 may be formed as a plurality of layers and may include one or more reinforcing materials. The dimensions of the shear element 40 may be determined based on the expected load, the desired frequency response and the desired axial to radial stiffness ratio for the mount.

The shear element 40 may be bonded to the outer case 20 and the mounting wall 33 using any method that provides a sufficient bond shear strength to withstand the shear stresses experienced when the pressure vessel 60 is pressurized and loaded. For a mount pressurized to 500 psi and carrying a 100,000 lb. static load, such shear stresses may be on the order of 1500 lbs/in. The shear element 40 may be secondarily bonded using a cyanoacrylate or other suitable adhesive. Alternatively, the shear element 40 may be cured in place to form a primary bond with either or both of the outer case 20 and the mounting wall 33.

The lower surface of the upper plate 32, the mounting wall 33, the shear element lower surface 46, the inner surface 25 of the outer case 20 and the bottom wall is 23 combine to define the pressurization chamber 62 of the pressure vessel 60. Prior to loading, the load platform 30 and shear element 40 are substantially coaxial with the outer case axis 21. It will be understood that the dimensions of the various components of the equipment mount 10 may be varied according to specific applications and environments. The components of the pressure vessel 60 may be configured to withstand the forces associated with a chamber pressure up to about 500 psi.

Although the embodiments illustrated and discussed herein use circular components for simplicity and ease of construction, it will be understood that other geometries may be used. For example, although the outer case 20 is depicted in FIGS. 1 and 2 as a circular cylinder, it will be understood that the outer case 20 may be formed as a non-circular cylinder. The other components of the equipment mount would then be formed with corresponding non-circular geometries.

The equipment mount 10 may also include a pressurization port 70 that can be used to fill the chamber 62 to the desired pressure using an external pressurization source (not shown). The external pressurization source may be selectively connected to the equipment mount 10 using a gas line connected to a pressurization valve 72 mounted to the pressurization port 70. Once a desired operational pressure is achieved, the port 70 may be closed off by closing or capping the valve 72. The gas used in the chamber 62 is preferably air but other gases such as nitrogen may also be used. The pressurization port 70 can also be used to place the chamber 62 in fluid communication with an additional volume (not shown) so as to change the response characteristics of the equipment mount 10. Although the pressurization port 70 is shown as passing through the wall of the outer case 20, it will be understood that the pressurization port 70 may also be located so as to pass through the bottom wall 23 or the load platform 30. It will also be understood that one or more additional ports may be provided. This would allow for one port to be used to increase the effective volume of the chamber 62 and a second port to be used to pressurize the chamber 62.

In an illustrative configuration, the outer case 20 has an outer diameter of 20 inches, a wall thickness of 0.5 inches and a height of 5.0 inches. The mounting wall 33 has an outer diameter of 15 inches and a wall thickness of 0.5 inches. The upper plate 32 and the bottom wall 23 each have a nominal thickness of 0.5 inches. The shear element thickness dimension is 1.8 inches. The outer diameter of the base plate 22 is 23 inches, giving the equipment mount an overall footprint of 415 square inches. The thickness of the mounting flange 24 is 1.0 inch.

The transfer impedance performance of the illustrative configuration was assessed using a finite element model. The finite element model included a hyper-elastic material model for the shear element 40 and a rigid assumption for the outer case 20, base plate 22 and load platform 30. The rigidity assumption provides valid results for use in assessing the impedance of the mount 10 because the case components are at least 100 times as stiff as the shear element 40. The air inside the chamber 62 is modeled as acoustic and fluid interaction elements, which transfer pressure and volume information as the model is exercised.

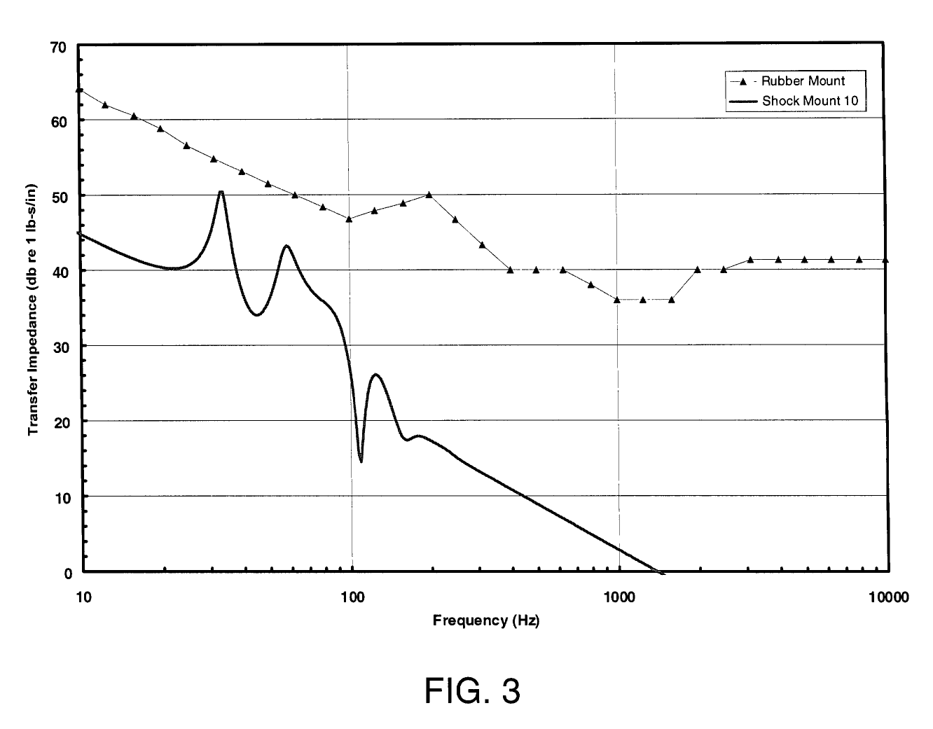

FIG. 3 illustrates the transfer impedance performance of the illustrative configuration of a shock mount 10 as determined using the finite element model. Transfer impedance is a measure of the vibration energy transmission through an isolating device and is generally used to provide a relative performance indicator for a given isolation mount. Typically, transfer impedance is measured by forcing one side of a mount with a sinusoidal velocity input, while monitoring force levels on the other side of the mount. Velocity and force are then combined in the following equation to yield transfer impedance:

$$X ( f ) = 20 \cdot {Log}_{10} ( \frac{V}{F} )$$

$$Where X ( f ) = Transfer Impedance$$

$$f = Frequency$$

$$V = Velocity$$

$$F = Force$$

In general, the impedance of a mount can be quantified in dB levels across a wide frequency range. The lower the impedance across the range, the more robust the mount is considered to be. FIG. 3 shows a comparison of the illustrative mount configuration compared to a traditional, monolithic rubber mount. It can be seen that, for a wide frequency range, the illustrative shock mount 10 of the present invention transfers much less energy than the traditional rubber mount when carrying the same weight load. The relative peaks and valleys of the impedance trace are determined by the resonant behavior of the mount 10. Some of these peaks are associated with the dynamics of the shear element 40. It should be noted that the finite element model did not include the effects of damping, which would significantly reduce the relative peaks at the associated frequencies.

The equipment mount 10 can also provide significant lateral low frequency vibration isolation. Typical pneumatic mounts, such as air springs, have axial to radial stiffness ratios on the order of 10:1. Accordingly, these mounts provide no significant attenuation of low frequency (i.e., less than about 5.0 Hz.) vibration in the lateral (radial) direction. Further, the stiffness ratio of these mounts is essentially fixed. In substantial contrast, the stiffness ratio of the equipment mount 10 of the invention can be established anywhere from about 1:5 to about 5:1 depending on the material and cross-section used in the shear element 40 and on the pressure in the chamber 62. Consequently, if it is desirable to have essentially the same low frequency response laterally as axially, the equipment mount can be configured to provide a 1:1 axial to radial stiffness ratio. Moreover, because the axial stiffness of the shear element 40 changes depending on the degree of deformation of the shear element due to pressurization, the axial to radial stiffness ratio of the equipment mount 10 can be varied after installation by varying the pressure in the chamber 62. It will be understood by those having ordinary skill in the art that the axial stiffness of the equipment mount 10 will be increased approximately proportionately to the chamber pressure squared. On the other hand, for the typical shear element geometries and pressures used in the invention, the radial stiffness of the equipment mount 10 will remain relatively constant with chamber pressure. It can therefore be seen that a 50% increase in chamber pressure will produce an increase in the axial to radial stiffness ratio on the order of 125%. This variability in stiffness ratio allows the equipment mount 10 to be tuned to adjust to changing load configurations without removing or dismantling the equipment mount 10.

It can therefore be seen that the equipment mount 10 of the invention provides a significant ability to be tuned after installation. Response of the equipment mount 10 can be adjusted either by changing the pressure in the chamber 62 or by adding effective volume to the chamber 62 by connecting the port 70 to an additional chamber or reservoir or by changing both the chamber pressure and the effective volume.

The equipment mount 10 of the invention can be used as a purely passive device or can be used in conjunction with an active control system. If used with an active control system, the equipment mount 10 may be provided with displacement and chamber pressure sensors that provide feedback information to the control system. Displacement sensors may be mounted inside the pressurization chamber 60 for determining the displacement of the load platform 30 relative to the bottom wall 23. Any conventional displacement sensor may be used including optical and linear variable differential transformer (LVDT) sensors. The displacement sensors used may be configured for monitoring axial or radial displacement or both axial and radial displacement of the load platform 30.

It will be understood by those of ordinary skill in the art that the relative displacement of the load platform 30 or a load supported by the load platform may also be monitored using conventional displacement sensors mounted external to the equipment mount 10.

Pressure sensors may be mounted inside the pressurization chamber 60 or may be mounted to ports through any of the walls defining the pressurization chamber 60. Chamber pressure may also be monitored through the pressurization port 70 or a line attached thereto. Cabling from internally mounted sensors may be routed through a passage in the load platform 30, the outer case 20 or the base plate 22.

Displacement and chamber pressure information may be used by a controller in a feedback loop to adjust the response of the equipment mount 10 by adjusting the pressure in the pressurization chamber. This can be accomplished by maintaining a connection between the pressurization chamber 60 and a pressurization source having a valve that can be selectively opened or closed by the controller to adjust the chamber pressure. The equipment mount 10 may also be used in conjunction with other isolation components including, for example, springs and active or semi-active dampers.

The invention provides significant advantages in performance and flexibility over previous pneumatic mounts and air springs. Embodiments of the invention provide low frequency isolation mounts that are adaptable to varying equipment mass and mass distribution. It will be understood that the equipment mounts of the invention may be used in any orientation and are not limited to isolation in a single degree of freedom. Further, although particularly well suited to use in isolating large masses, the invention is not limited as to the size or mass that can be isolated. Multiple equipment mounts according to the invention may be used in combination.

Other embodiments and uses of the invention will be apparent to those skilled in the art from consideration of the specification and practice of the invention disclosed herein. The specification and examples should be considered exemplary only. The scope of the invention is limited only by the claims appended hereto.

What is claimed is:

1. A pneumatic equipment mount comprising:
a base plate;
an annular outer case extending upwardly from the base plate and having opposing upper and lower case ends, the lower case end being closed by the base plate, the outer case comprising a case wall defining a cylindrical case inner surface;
a load platform comprising a substantially circular upper plate and a cylindrical mounting wall, the cylindrical mounting wall having a cylindrical mounting wall outer surface and being coaxially mounted to the upper plate adjacent the outer circumference of the upper plate so that the cylindrical mounting wall extends downwardly from the upper plate; and
a toroidal shear element comprising a cylindrical outer toroid surface attached to a portion of the cylindrical case inner surface and having a cylindrical inner toroid surface attached to a portion of the cylindrical mounting wall outer surface, the inner and outer toroid surfaces being connected by upper and lower toroid surfaces, the toroidal shear element being formed from an elastomeric material;
wherein the base plate, the annular outer case, the load platform and the toroidal shear element combine to define a pressure chamber.

2. A pneumatic equipment mount according to claim 1 wherein the load platform is adapted for supporting a load.

3. A pneumatic equipment mount according to claim 1 wherein the base plate, the annular outer case, the load platform and the toroidal shear element are sized and configured so that the pressure chamber may be pressurized to at least about 500 psi.

4. A pneumatic equipment mount according to claim 1 wherein the toroidal shear element is formed from an elastomeric material having a cured hardness in a Shore A durometer range of 30-70.

5. A pneumatic equipment mount according to claim 1 wherein the toroidal shear element is formed from an elastomeric material having a cured hardness in a Shore A durometer range of 40-60.

6. A pneumatic equipment mount according to claim 1 wherein the toroidal shear element is secondarily bonded to at least one of the portion of the cylindrical case inner surface and the portion of the cylindrical mounting wall outer surface using an adhesive.

7. A pneumatic equipment mount according to claim 1 wherein the toroidal shear element has a substantially rectangular radial cross-section.

8. A pneumatic equipment mount according to claim 1 wherein the upper and lower toroid surfaces are concave.

9. A pneumatic equipment mount according to claim 1 further comprising a pressurization port formed through the case wall.

10. A pneumatic equipment mount according to claim 1 further comprising means for measuring a displacement of the load platform relative to the base plate.

11. A pneumatic equipment mount according to claim 1 further comprising a displacement sensor disposed within the pressure chamber, the displacement sensor being configured for determining a displacement of the load platform relative to the base plate, and a pressure sensor in fluid communication with the pressure chamber for monitoring pressure therein.

12. A pneumatic equipment mount according to claim 11 further including means for controlling a pressure level in the pressure chamber, the means for controlling a pressure level including a valve attached to the pressurization port and a gas line in fluid communication with the valve, the gas line being operably connectable to a pressurization source.

13. A pneumatic equipment mount according to claim 12 wherein the means for controlling a pressure level includes a feedback control system in communication with the displacement sensor, the pressure sensor and the valve.

14. A pneumatic equipment mount comprising:
a base plate;
an annular outer case extending upwardly from the base plate and having opposing upper and lower case ends, the lower case end being closed by the base plate, the outer case comprising a case wall defining a cylindrical case inner surface and having a pressurization port formed therethrough;
a load platform comprising a substantially circular upper plate and a cylindrical mounting wall, the cylindrical mounting wall including a cylindrical mounting wall outer surface and being coaxially mounted to the upper plate adjacent the outer circumference of the upper plate so that the cylindrical mounting wall extends downwardly therefrom, the load platform being adapted for supporting a load;
a toroidal shear element comprising a cylindrical outer toroid surface bonded to a portion of the cylindrical case inner surface and having a cylindrical inner toroid surface bonded to a portion of the cylindrical mounting wall outer surface, the inner and outer toroid surfaces being connected by upper and lower toroid surfaces, the toroidal shear element being formed from an elastomeric material, wherein the base plate, the annular outer case, the load platform and the toroidal shear element combine to define a pressure chamber;
a displacement sensor disposed in the pressure chamber, the displacement sensor being configured for determining a displacement of the load platform relative to the base plate;
a pressure sensor in fluid communication with the pressure chamber for monitoring pressure therein;
means for controlling a pressure level in the pressure chamber, the means for controlling including a valve attached to the pressurization port, a gas line in fluid communication with the valve, the gas line being operably connectable to a pressurization source, and a feedback control system in communication with the pressure sensor, the displacement sensor and the valve.

15. A pneumatic equipment mount according to claim 14 wherein the base plate, the annular outer case, the load platform and the toroidal shear element are sized and configured so that the pressure chamber may be pressurized to at least about 500 psi.

16. A pneumatic equipment mount according to claim 14 wherein the toroidal shear element is formed from an elastomeric material having a cured hardness in a Shore A durometer range of 30-70.

17. A pneumatic equipment mount according to claim 14 wherein the toroidal shear element is formed from an elastomeric material having a cured hardness in a Shore A durometer range of 40-60.

18. A pneumatic equipment mount according to claim 14 wherein the toroidal shear element is secondarily bonded to at least one of the portion of the cylindrical case inner surface and the portion of the cylindrical mounting wall outer surface using an adhesive.

19. A pneumatic equipment mount according to claim 14 wherein the toroidal shear element has a substantially rectangular radial cross-section.

20. A pneumatic equipment mount according to claim 14 wherein the upper and lower toroid surfaces are concave.
